(19) United States
(12) Patent Application Publication
(10) Pub. No.: US 2018/0119398 A1
(43) Pub. Date: May 3, 2018

(54) SONIC VALVE

(71) Applicant: AMIN ZEINVAND MOGHADDAM, TEHRAN (IR)

(72) Inventor: AMIN ZEINVAND MOGHADDAM, TEHRAN (IR)

(21) Appl. No.: 15/856,095

(22) Filed: Dec. 28, 2017

(51) Int. Cl. E03C 1/05; F16K 37/00

(52) U.S. Cl. CPC E03C 1/057; E03C 2001/0418; F16K 37/0091; F16K 37/0058

(57) ABSTRACT

The purpose of the invention is to help prevent water loss and also increase public health. In this invention, by using the new and advanced technology, the physical contact of the hand or any other objects with the valve has been eliminated and all possible situations to use the valve has been done electronically and digitally. In addition, by using the nanotechnology, sterilized and antimicrobial water can be used, while the valve is controlled by sound. With these systems, the wastage of water is decreased in very high percentage, and there is a great hope to prevent the loss of water resources in this area.

### BACKGROUND OF THE INVENTION

Water resources are limited in all around the world, as can be expected, in the coming years, the main controversial issue will be over the water resources. Nevertheless, people are neglected and it seems they have not perceived the value of it perfectly. The most important thing that gave rise to this idea in my mind was the loss of water in domestic consumptions such as in sinks and baths, as well as public toilets. Unfortunately, only by a few hours of investigation, it can be seen that a huge amount of fresh and potable water is lost in these areas. With the research on the valves and equipment that existed from the past, I noticed some flaws in this. The defects that caused the loss of water except from behavioral factors were one of the most important factors for this problem.

In these years, many inventors and designers have been working on the various fields of these valves, and their results have not yet been able to achieve as expected. Another discussion about the valves I was considering was the health of these valves. As a matter of fact, when you have a foul hand you are going to wash them, and given that all the valves require physical contact with them to open and close it and also set it, so you will transfer germs and contaminations to the next persons. It should be noted that microbes do not easily disappear from the surface of the valves. Major research on the valve has been on the topic of opening and closing, and few have looked at public health.

Another important consideration was the public use of valves. A human being in any state of life, whether it is healthy or disabled, needs to water. People who, unfortunately, have disabilities and do not have the ability to open and close the valves, in this context also need others help, which is one of the various abnormalities in this community. These general problems and technical defects, such as supply energy for the electronic valves, the specific type of sensors which were used, the way valves was opened and closed, and other reasons, have helped me to address these deficiencies with more and better technologies in designing and manufacturing.

### SUMMARY OF THE INVENTION

Many researches and studies have been done on how to make smart valves in the world. We have also been planning and testing for as many years, so that we can present a simple functional design for one device.

In this invention, an infrared sensor has been used to identify the object or hand for water use, which has the ability to execute various orders by specifying a specific interval. In this valve, in order to omit the physical contact with the valve in general, we have planned the sensor so that the water can be connected and disconnected at a distance of 4 cm, at a distance of 6 cm, adjust the water temperature and at a distance of 8 cm from the valve the water pressure has been controlled.

In addition, the circuit is designed to allow the user to set the temperature and pressure as default, so that if anyone immediately places their hands at 4 cm away, the default settings are considered. These sensors do not have any noise or error in relation to the surrounding ambient light and do not cause any problems with the valve function. Another part of this valve is dependent on the heat detection sensor. Its function is that if the user wishes the sensor will be activated and, once the hand is in front of the valve, determines the temperature of the body, then the water temperature will be determined and if the hands are contaminated and there is less heat detection for the sensor the water temperature will be boosted to the predetermined degree to eliminate contamination more easily.

For easier use in this valve, the voice control system is used so that everyone can easily use this valve. Because of the limitations of voice processing in circuits, this system can be defined for specific people, and the voice must be detected in advance for the circuit so that it can satisfy the user's needs with every use as soon as it is detected. For timely disconnect operation, the valve begins to function after detecting the infrared sensor and sending the pulse to the circuit which is done by a low voltage and low current.

In this invention, a gradual electronic valve is used to adjust the temperature and pressure of the water, which can affect the valve function by changing the flow in various phases. One of the most important parts in this invention is to pay attention to how to supply the energy needed to run the circuit. These valves use rechargeable batteries that have the ability to charge continuously and can simultaneously supply and charge the energy of the circuit. We used thermoelectric materials in these valves to charge these batteries. One of the properties of thermoelectric materials is that if we put two poles in a different temperature, we can generate electrical energy.

In this invention, by placing these materials between cold and hot water pipes, we can also obtain the energy needed to charge the batteries. Another unique function of this valve is the use of nanoparticles for inhibiting bacteria in water. The pipes and chambers which the water passes through, all are covered by Nano-scale materials that can eliminate water contamination; also sterilize hands and containers to a high degree. The bubble system and pressure reduction are among the parts commonly used by the majority of valves. The mentioned sections provide a concise summary of how the device works.

### BRIEF DESCRIPTION OF THE DRAWINGS

FIG. 1 (a, b and c), displays a section including the main body of the mechanical electronic valve, which has all the components, such as an electronic valve, set screw of temperature and pressure, water pressure output, cold and hot water inputs. The body is made of plastic which is impregnated with silver Nano-scale materials.

FIG. 2, Displays a Servo/6v/DC motor; that employs the set crew of electronics valve at all points.

FIG. 3, Displays a Bubble system to reduce water consumption.

FIG. 4, displays an Electronic valve, this is the type of On/Off model. The voltage of this valve is 3V.

FIG. 5, displays a set screw of temperature and pressure.

FIG. 6, displays a Smart sensor which is equipped with microphone for sonic control of the electronic valve.

FIG. 7, displays a schematic of electronic circuit board used in electronic valve.

FIG. 8, displays the circuit of the sonic control.

FIG. 9, displays the batteries for feeding and thermoelectric materials for electricity generation.

### DETAILED DESCRIPTION OF THE INVENTION

This part is the main body of the electronic valve which is composed of different parts. This piece is made from thermoplastics. These plastic materials transform into a liquid by heat, and after forming and removing the heat, find their final shape. These materials can be recycled as often as possible. It should be noted that the thermoplastics consist of 10 members, which is made of polyethylene plastic. Polyethylene is produced at high molecular weight and has high hardness.

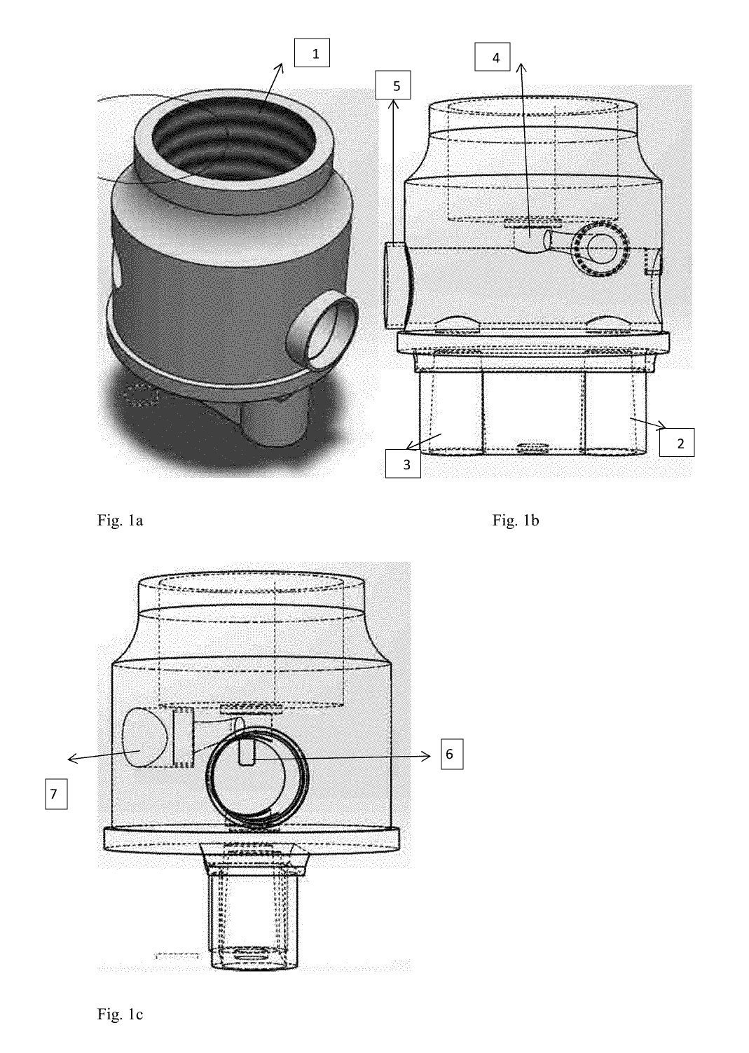

These plastics are very resistant to wear and corrosion. We used Nano silver powder for sterilization of water and its outlet channels. This powder is added to the material during the melting of the plastic and after the molding of the body, it is permanently Nano articulated and takes advantage of antibacterial benefits. In this piece, the electronic valve was used to connect and disconnect the current of water, shown in FIG. 1. This valve is sealed with thread on the piece. Due to the strength of the polyethylene, these threads are also made from the same polyethylene. The gap between gears is chosen so fine for better sealing.

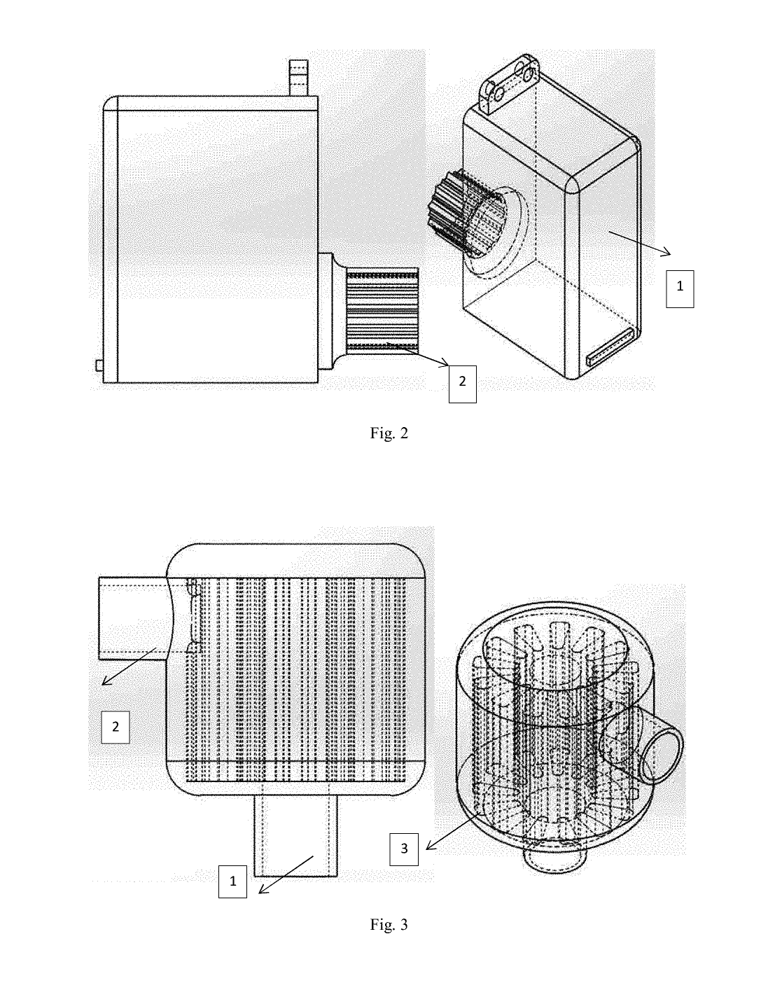

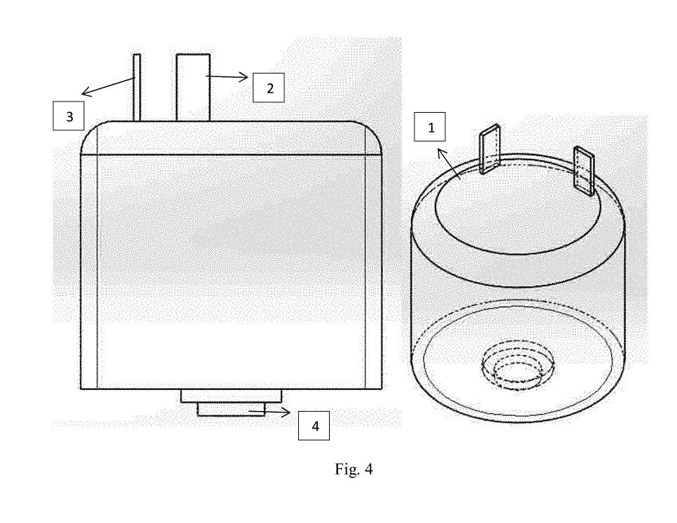

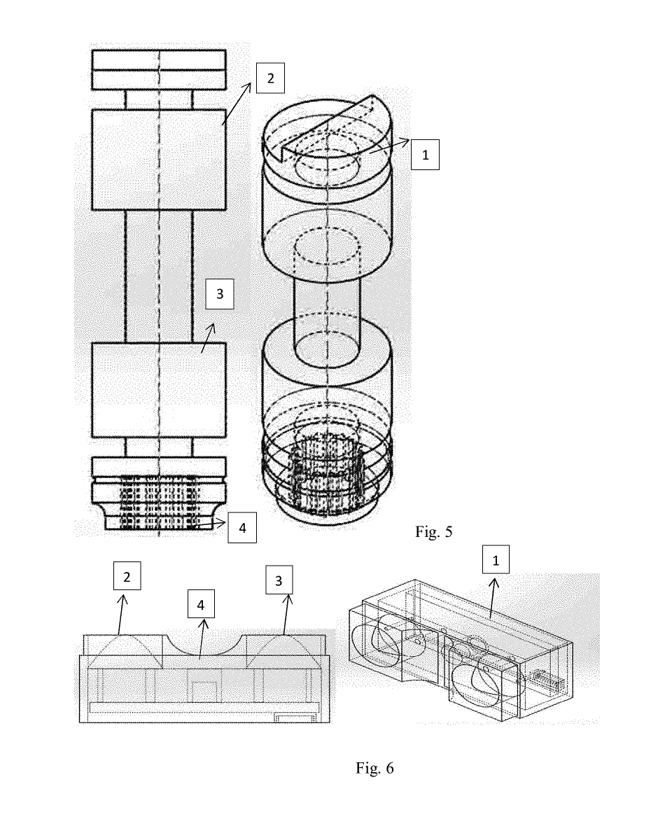

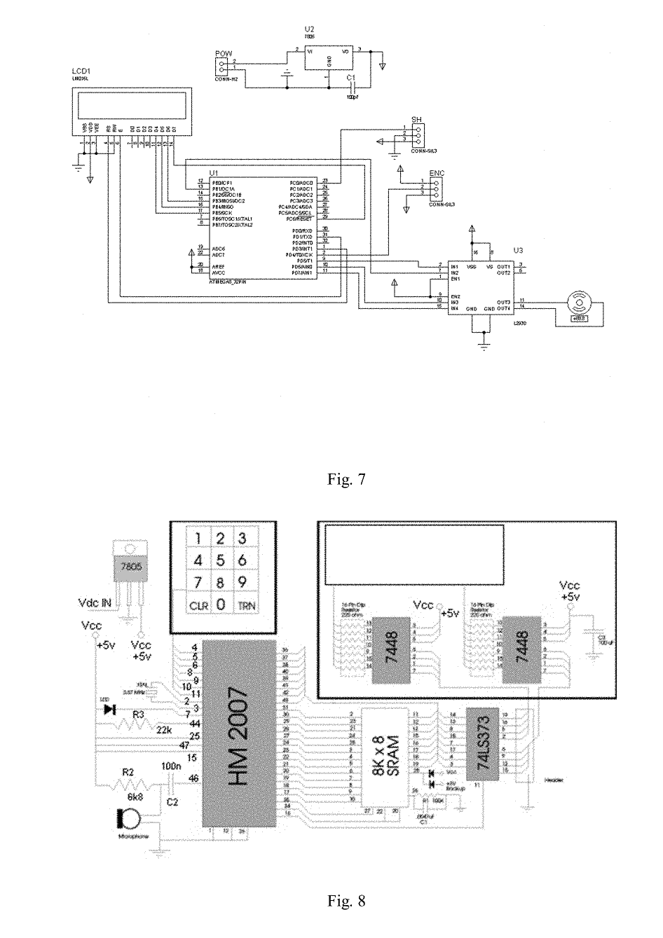

The duct which is shown in FIG. 2 is for cold water input, and the duct which is shown in FIG. 3 is for hot water input. The hoses to these ducts are connected and sealed with a variety of gaskets to the valve body, and we use an automatic bolt to close these hoses against water pressure. After entering the water to the mechanical section through input ducts, another duct is required to exit. In this system, the output duct, shown in FIG. 4, is located after the valve's set screw, which moves the valve up and down to direct the water towards the outlet pipe.

After the water passes through this passage, it will move towards the bubble system. Because the water pressure is high in this section, we have designed the duct so that we can come out with increasing water pressure. For low and high pressure of water or cold and hot water, we have designed set screw that, after being placed in the duct 5, can easily move in this duct and control the different water outflow conditions.

For this design, there is no need for 360 degrees of turning, and also for the better control of the function of the valve, we have used the stud, shown in 6. The presence of this stud makes the program very timely. To remove water from the mechanical part, we use the bubble system from the duct 7. This conduit transfers the output water into the bubble part by connecting the hose.

We use the servo motor for the different modes of the water output 8 in the illustration. The specifications of this servo include:

Starting torque: 10 Kg/Cm
Operating speed: 0.20 sec/60 Degree (4.8)
Working voltage: 4.8-7.2 v
Dead bandwidth: 10 us

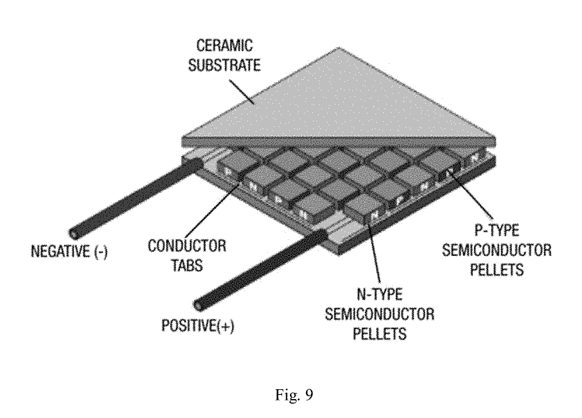

To connect the engine to the set screw, output of gearbox of the engine shown in FIG. 9 is used. The gears are made of brass and are tiny and designed to allow better and more confident connectivity. This engine provides us with the necessary commands from the circuit based on the degree of displacement and various modes, including changes in pressure and temperature.

The bubble system has been used to optimize water use. After leaving the mechanical part, the water enters the bubble system that is shown in the FIG. 11 and after passing through the grooves of bubble system 12, the water is mixed with the air, and then a soft, fluid stream of air blended water is directed toward the output of the handle through the bubble system output which is shown in FIG. 10.

The shape of this bubble is similar to that of the mechanical body of the polyethylene plastic with a silver Nano mixture. The method of preparation is the same as the previous one, and we will get the final piece by melting and molding.

The connection and disconnection operation in the valve is handled by the electronic valve 13 after receiving the pulse from the smart sensor. This electronic valve shown in FIG. 13, after receiving the corresponding pulse from the circuit which has been connected by the bases 14 and 15 sends a pulse to open the water duct and sends another pulse to close the water duct.

The action of connecting and disconnecting the flow of water in this valve is shown by the set screw of the valve shown in FIG. 16. The main body of the set screw is stainless steel, but since the steel does not have magnetism, it is covered the part that connects to the magnet of electronic valve with a layer of iron. The body of this valve is made of plastic, and is designed to be sealed, preferably in the form of a fully sealed molding that does not have any penetration. This electronic valve will start with Voltage 3V, and in load state, it will consume 20 mA current from the batteries in a few seconds.

After the command is given from the circuit to the engine to change the exhaust state, the engine transfers this order, which includes rotational motion, by its gearbox to the set screw shown in FIG. 17. The connection between the axis of the engine and the rod is carried out by a dip in the form of a chiliad pin shown in FIG. 20.

After the engine moves the rod, the water inlet valves control the water withdrawal by the cam of the rod, as shown in FIGS. 18 and 19. These cams are designed eccentric in order to simultaneously adjust water pressure and heat. The rod is stainless steel and resistant to any corrosion.

When the hand places under the faucet, the pulse is sent to circuit from the smart sensor, shown in FIG. 21. The sensor is consists of a receiver 22 and a transmitter 23 which are the kind of optical infrared. Given the importance of this sensor, more information is provided below. These new distance sensors all use triangulation and a smaller CCD linear arrangement to calculate the distance or the presence of objects in the field of view.

The basic idea is that: The IR light pulse is emitted by the emitter. This light is transmitted in the field of view; either collides with the object or continues. In the absence of an obstacle (object), the light is never reflected and no color is displayed. If the light is reflected from an object, it returns to the sensor and creates a triangle between the reflection point, the emitter and the sensor.

The angles in this triangle vary by distance from the object. The receiver portion of these new sensors is in fact a precision lens, which transmits reflected light to the CCD enclosed linear segments based on the angle of the triangle. The CCD arrangement can determine which reflected light is returned at any angle and therefore can calculate the angle of the object. This new distance measuring method is almost isolated against the interference of ambient light, and it shows a great unwillingness against the color of the object being detected. It is now possible to identify a completely black wall in the sun.

In this sensor, the microphone is used to sonic control of the valve, shown in FIG. 24. This microphone has an anti-shock coating to reduce noise caused by ambient airflow. The microphone software is designed in such a way that it does not detect any sound when the receiver receives and exits the water out of the circuit. This is due to the lack of interference with the sound of water loss and the lack of interference with the smart sensor. The frequency range which is supported by this microphone is 20 Hz-20 KHz.

In this figure, you will see the different parts that make up the entire electronic circuitry. Accordingly, these parts are:

25: The LCD is positioned to display information such as pressure and water temperature. The LCD has sixteen bases, with base numbers 1, 3, 5, 15 for negative connection, and bases number 2, 16 for positive connection and other bases for data exchange.
26: A power port that receives more than 5V voltages and passes to the regulator.
27: The regulator is 7805. This regulator will confirm the input voltage and convert the input voltage to 5V. In this regulator, the base 1 is used to enter the voltage, the base 2 for negative connection, and the VCC or positive base.
28: Is the 100 nf lens capacitor. This capacitor is a noise canceller is in the circuit.
29: Infrared sensor input port. Base 1, this sensor is used for signal transduction, base 2 for negative connection, and base 3 for positive connection.
30: Is the input port of servo engine. In this port, base 1 is for positive connection, base 2 for receiving signal and base 3 for negative connection.
31: Is L293 Driver. This driver is used to boost the flow of power to the electronic valve and engine. In this driver, the bases 15, 10, 7, 2, which are the voltage input from the micro-base 1, 9 is IC activator. Base 16, VCC or positive and the bases 4, 5, 12, 13 is for negative connection and base 8, VS for the voltage of engine and base 3, 6, 1
32: Is the On/Off electronic valve. The base of this electronic valve is used for the bases 11 and 14 of the L293 driver.
33: IC Micro ATMEGA8. The IC can be referred to as a small computer. This IC processes all input and output information. Port B, C, D from port B for the LCD, port C for infrared sensor and port D is used for servo and electronic valve.

This circuit is capable of detecting noise from the sound signal. In this circuit, a level of sound is used which is higher than noise. This circuit is used to transfer voice commands from the keyboard. By pressing any of the keys you can transfer the voice commands to the circuit. Input voltage after passing the regulator 7805 to the 5V regulator which is shown in FIG. [34] reduced and entered the circuit. After the voltage is released from the regulator, this voltage is transmitted to the resistor shown in 35. To receive audio signals requires a strong microphone and anti-noise. The characteristics of the microphone were talked about in the past.

IC HM2007 needs to be used to process the transferred voice from the microphone which is shown in FIG. 36. The output of this IC is 8-bit, which means that any microcontroller can be connected to the circuit. This IC has the ability to recognize 20 words from each other.

The circuit uses 8 k 8×RAM, shown in FIG. 37, as a memory. A backup battery is included in the mainboard for the SRAM. This battery holds the words stored in memory, without the backup battery you will have to reboot the circuit after each power cut.

For de-multiplexing the address signals in the address/data base, it is used a latch to capture addresses. The most used latch IC is LS373 74 which is shown in FIG. 38. ADO8088 to ADO-AD15AD7 and 8086 goes to the latch LS373 74. ALE provides required signals for the latch operation. For 8086 the outputs of LS373 74 are consist of the 16-bits address of AO-A15 in 8088. The outputs of LS373 74 are also included 8-bits AO-A7 and other 8-bits is A8-A15 address which it comes directly from the microprocessor.

Four last bits of the A16-A19 address are taken from the bases 35-38. In each of the above systems, all the addresses must be latched to provide a stable startup address system. Converters are required to convert signals into circuit. This converter is shown in FIG. 39. After the signals are converted, these signals are transmitted to the command line by the circuit number 39.

We need 5V electrical energy to feed the electronic circuits. This energy is generated through lithium-ion batteries shown in FIG. 40. These batteries do not require any charging for at least 3 months, and they will completely eliminate the need for all circuits, with a large amount of power which they provide.

The general specifications of these batteries are as follows: Voltage: 3.7V; Capacity: 2400 mAh.

In this plan we have used thermoelectric materials shown in FIG. 41 to increase battery life and prevent unplanned volatility in the system and charge the batteries. These materials are composed of carbon nanotubes, which can produce a lot of flow through the large temperature difference between the two surfaces. When these materials are exposed to temperature differences, the electrons and holes move away from the hot side to the cold side due to the effect of the siphon, and this difference in temperature is converted to the output voltage.

1- A sonic valve system comprising:
An electric valve comprising a main body and a servo motor; multiple sensors having a receiver and a transmitter; and a microphone of sonic control of said valve; an LCD displaying water pressure, water temperature.

2- The sonic valve of claim 1, wherein said sensors are optical infrared sensors.
